(19) United States
(12) Patent Application Publication
(10) Pub. No.: US 2019/0240933 A1
(43) Pub. Date: Aug. 8, 2019

(54) Infusion Terminal Block

(71) Applicant: Jon Charles Dailey, JR., Scappoose, OR (US)

(72) Inventor: Jon Charles Dailey, JR., Scappoose, OR (US)

(21) Appl. No.: 16/270,472

(22) Filed: Feb. 7, 2019

Related U.S. Application Data
(60) Provisional application No. 62/627,877, filed on Feb. 8, 2018.

(51) Int. Cl. B29C 70/54; B29C 70/38; B29C 70/44; B29B 15/12; B29C 33/38

(52) U.S. Cl. CPC B29C 70/548; B29C 70/384; B29C 33/38; B29B 15/122; B29C 70/443

(57) ABSTRACT

An infusion terminal block that secures to a vacuum bag and receives a resin hose includes a prismatic body, a tube opening, and a plurality of channels. The tube opening that receives the resin hose concentrically traverses through the prismatic body from a bottom surface of the prismatic body. A stopper is laterally connected within the tube opening to stop the resin hose from touching a laminated surface. The plurality of channels traverses into the prismatic body from the bottom surface and in fluid communication with the tube opening. Resultantly, resin that is discharged through the resin hose travel through the tube opening and radially discharged into fibers thus forming the laminated surface. The infusion terminal block can optionally include a clip to secure the prismatic body to the laminate and other ancillary products.

The current application claims a priority to the U.S. Provisional Patent application Ser. No. 62/627,877 filed on Feb. 8, 2018.

### FIELD OF THE INVENTION

The present invention relates generally to an apparatus for an infusion terminal block. More specifically, the present invention is an infusion terminal block that provides a path for a plastic tube to transfers material during the resin infusion process.

### BACKGROUND OF THE INVENTION

Vacuum Assisted Resin Transfer Molding (VARTM) or Vacuum Injected Molding (VIM) is a closed mold composite manufacturing process. Generally, the resin transfer molding process uses a low viscosity polyester or vinyl ester resin along with fiberglass fibers to create a composite. The resin to fiberglass fiber ratio is important for determining the overall strength and performance of the final part, with mechanical strength being most influenced by the type of fiber reinforcement. The type of resin that is used primarily determine the corrosion resistance, heat distortion temperature, and surface finish. More specifically, resins that are utilized within the resin transfer molding process have low viscosities due to the limited pressure differential provided by the vacuum pump. The main problem with the resin transfer molding process is the air leakage into the vacuum bag as air leakage can be caused by a defect in the vacuum bag, an improper application of the sealant tape, or an improper seal at the points where the resin hose meets the vacuum bag. Resultantly, air leakages can cause resin to improperly flow through the mold and also lead to the formation of air bubbles that form voids when the composite cures with air bubbles inside of it. Even though the air leakage is currently detected through visual inspection, vacuum pressure drop, and sound magnification, these methods are generally ineffective due to noisy working environments, existing terminal block design flaws, and human errors.

It is therefore an objective of the present invention to provide an infusion terminal block to eliminate air leakage into the vacuum bag at the points where the resin hose and the vacuum bag meets and to evenly distribute the resin into the ancillary materials. More specifically, a top end of the present invention easily covers by the vacuum bag as the resin hose is inserted into the top end of the present invention. Due to the flat surface configuration of the top end, the present invention eliminates vacuum bag wrinkles that generally present around the top end of the existing terminal blocks. As a result, the present invention functions as an ancillary component in the resin transfer molding process that is utilized in the composite industry.

### BRIEF DESCRIPTION OF THE DRAWINGS

FIG. 1 is a top perspective view of the present invention.

FIG. 2 is a bottom perspective view of the present invention.

FIG. 3 is a top view of the present invention, showing the lateral connection of the stopper to the tube opening.

FIG. 4 is a bottom view of the present invention, showing the radial configuration of the plurality of channels.

FIG. 5 is a side view of the present invention, showing the plane upon which a cross sectional view is taken shown in FIG. 6.

FIG. 6 is a cross section view of the present invention taken along line A-A of FIG. 5.

FIG. 7 is a top perspective view of the present invention with the clip.

FIG. 8 is a side view of the present invention with the clip, showing the section upon that a detailed view is taken shown in FIG. 9.

FIG. 9 is a detailed view of the present invention taken within section B of FIG. 5.

FIG. 10 is a bottom view of the present invention with the clip, wherein the dash circular line illustrates the diameter of the tube opening.

FIG. 11 is a top perspective view of an alternative embodiment of the present invention, wherein the top surface is a semi-circular.

### DETAIL DESCRIPTIONS OF THE INVENTION

All illustrations of the drawings are for the purpose of describing selected versions of the present invention and are not intended to limit the scope of the present invention.

The present invention is an infusion terminal block that functions as an ancillary component for the process of resin infusion that is adapted in the composite industry. The present invention is a single body and receives a resin hose and provides a path for the resin hose to transfer resin to ancillary materials that form a laminate. The ancillary materials can include, but is not limited to, a layer of fibers, a layer of flow media such as a plastic netting, a layer of peel ply, and a vacuum bag. The present invention is preferably made of biodegradable plastic or any other types of biodegradable material that can be disposable.

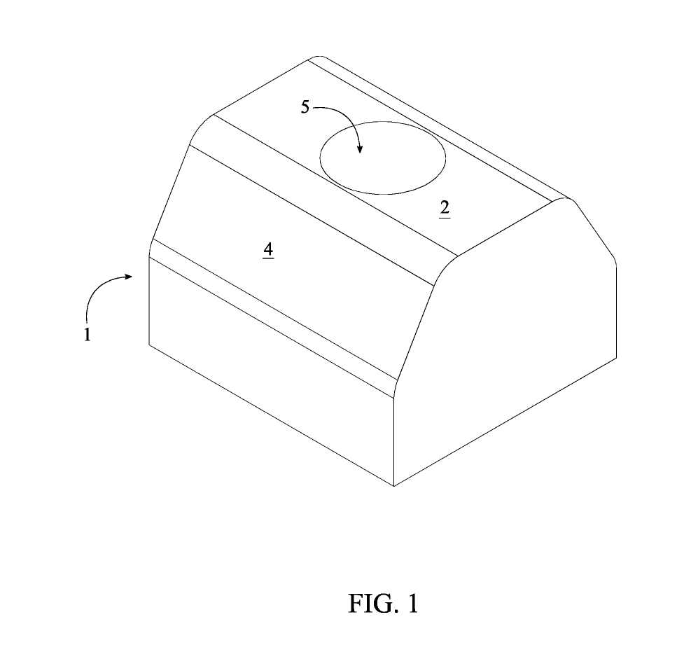

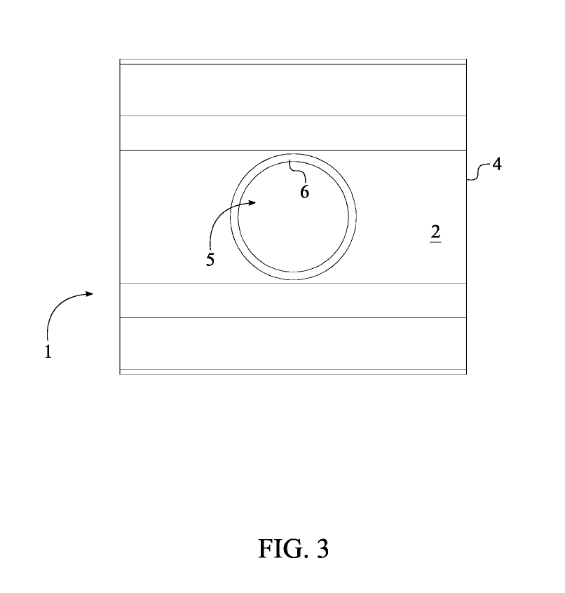

The present invention comprises a prismatic body 1, a tube opening 5, and a plurality of channels 7 as shown in FIG. 1-3. In reference to the general configuration, the tube opening 5 concentrically traverses through the prismatic body 1 from a bottom surface 3 of the prismatic body 1. The tube opening 5 also positions normal to the bottom surface 3. The resin hose is inserted into the prismatic body 1 through the tube opening 5 so that resin can be discharged into the prismatic body 1. The plurality of channels 7 traverses into the prismatic body 1 from the bottom surface 3 and is in fluid communication with the tube opening 5. As a result, resin from the tube opening 5 can be discharged into the ancillary materials through the plurality of channels 7.

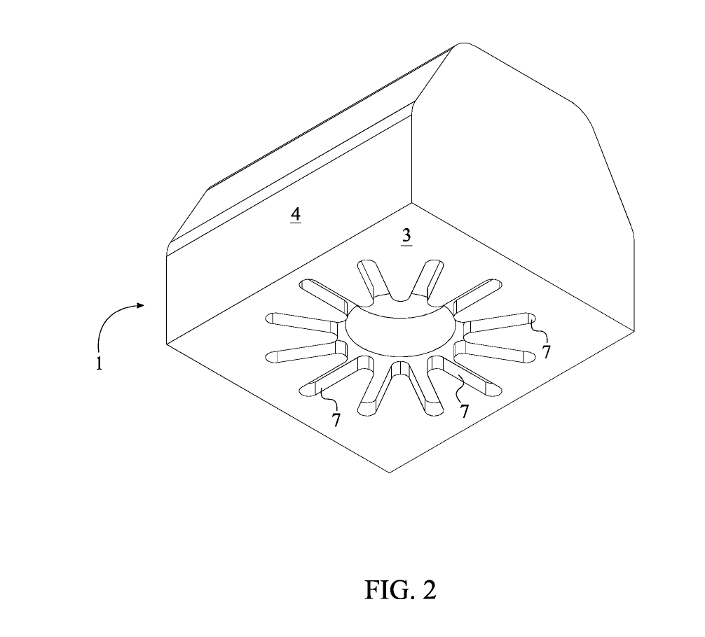

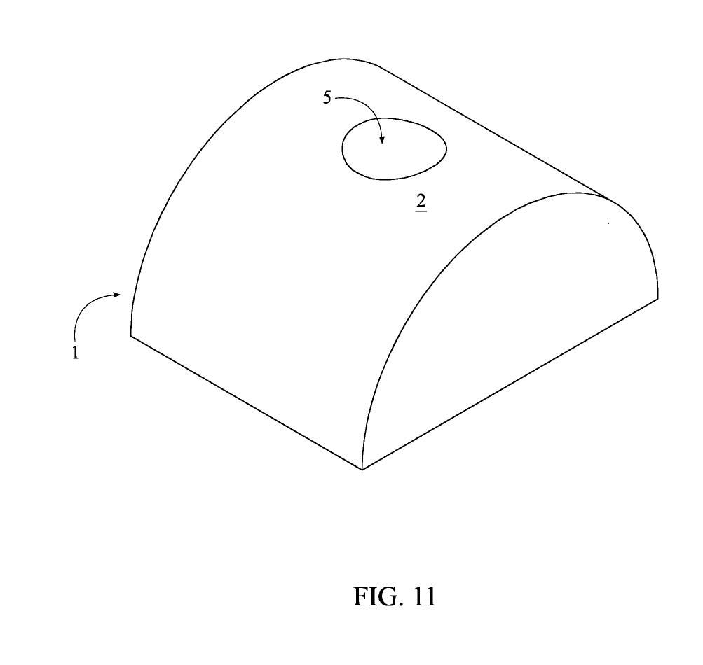

In reference to FIG. 1-2, the prismatic body 1 further comprises a top surface 2 in addition to the bottom surface 3 thus preferably delineating a hexagonal shape with two right angles. More specifically, the top surface 2 and the bottom surface 3 are positioned opposite of each other about the prismatic body 1 and laterally positioned of each other about the prismatic body 1. The top surface 2 generally positioned adjacent to the vacuum bag, and the bottom surface 3 generally positioned adjacent to the layer of flow media during the resin infusion process. A first base and a second base of the prismatic body 1, which are perpendicularly positioned to the bottom surface 3 and oppositely positioned of each other about the top surface 2 and the bottom surface 3 provide a surface area to grasp and maneuver the prismatic body 1. Furthermore, the first base and the second base delineate the same size and shape and are positioned parallel to each across the prismatic body 1. The top surface 2 also delineates a flat surface area so that the vacuum bag can hermetically seal around the prismatic body 1 without forming any wrinkles. In other words, the vacuum bag hermetically seals and superimposes over the top surface 2 to keep the vacuum bag flat and to eliminate generation of wrinkles. Elimination of wrinkles is an important step in the resin infusion process so that any imperfections in the laminate can be omitted. The vacuum bag is then smoothly extended into the layer of flow media and away from the prismatic body 1 thus keeping air from being sucked into the laminate. Even though the top surface 2 is preferably formed into the flat surface area, the top surface 2 can also be formed into a semi-circular surface area in an alternative embodiments of the present invention as shown in FIG. 11.

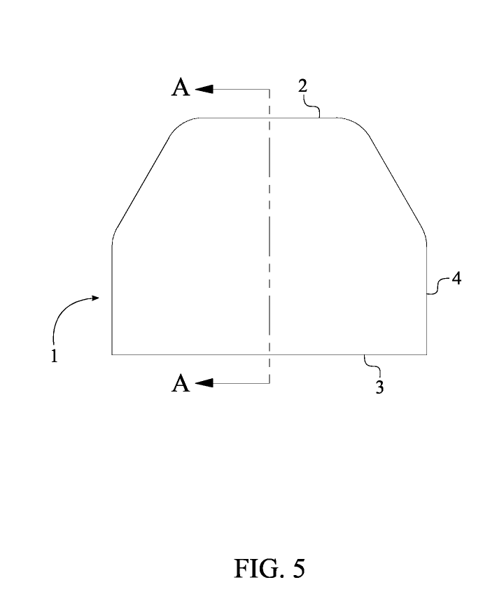

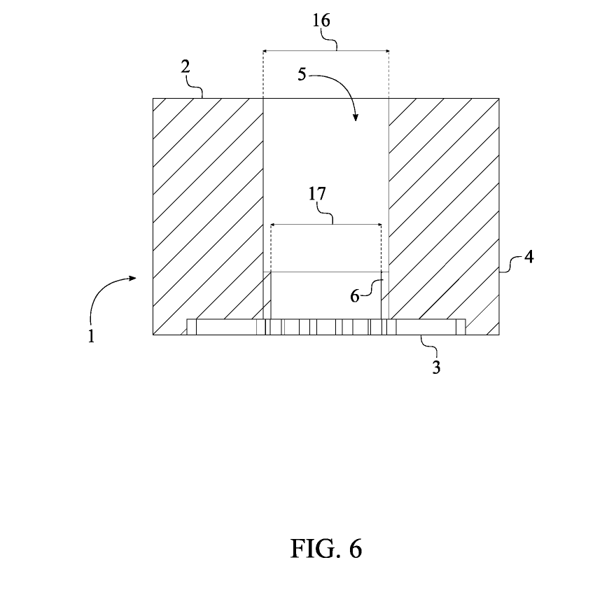

In reference to FIG. 5-6, the tube opening 5 is perpendicularly positioned to the top surface 2 and the bottom surface 3 so that the resin hose can be linearly inserted into the prismatic body 1. Due to the straight positioning of the resin hose within the prismatic body 1, the tube opening 5 is able to unnecessary bends within the prismatic body 1 that can block or restrict the continuous flow of resin.

In reference to FIG. 6, the present invention further comprises a stopper 6 that functions as a step down for the resin hose. More specifically, the stopper 6 is laterally connected within the tube opening 5 and positioned adjacent to the bottom surface 3. When the resin hose is inserted into the tube opening 5, the stopper 6 prevents the resin hose from touching the laminate surface that would otherwise slow down the continuous flow of resin. The stopper 6 is preferably a cylindrical sleeve, wherein a diameter 17 of the stopper 6 is smaller than a diameter 16 of the tube opening 5. As a result, the resin hose perimetrically rests upon the stopper 6 and positions away from the laminate surface when inserted into the tube opening 5.

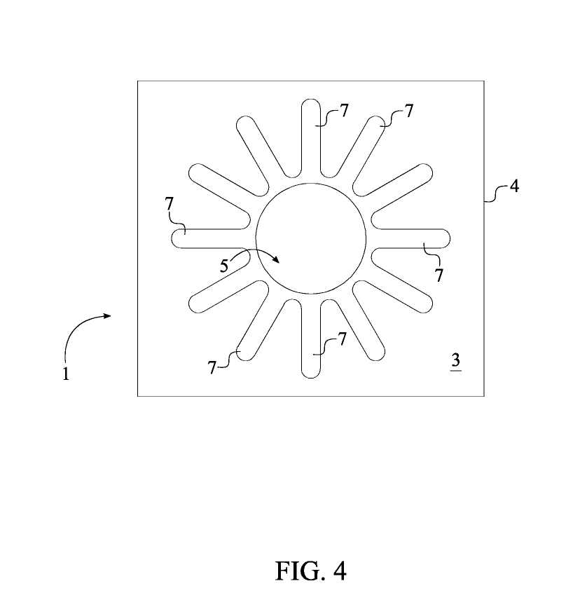

In reference to FIG. 2 and FIG. 4, the plurality of channels 7 is radially distributed around the tube opening 5 and is in fluid communication with the tube opening 5 through the stopper 6. The plurality of channels 7 facilitates resin flow into the layer of flow media and reduce blockage of foreign elements such as dust particles and solid materials. Due to the redial and concentric positioning of the plurality of channels 7 around the tube opening 5, resin can be uniformly distributed into each of the plurality of channels 7 as the tube opening 5 enables the resin flow.

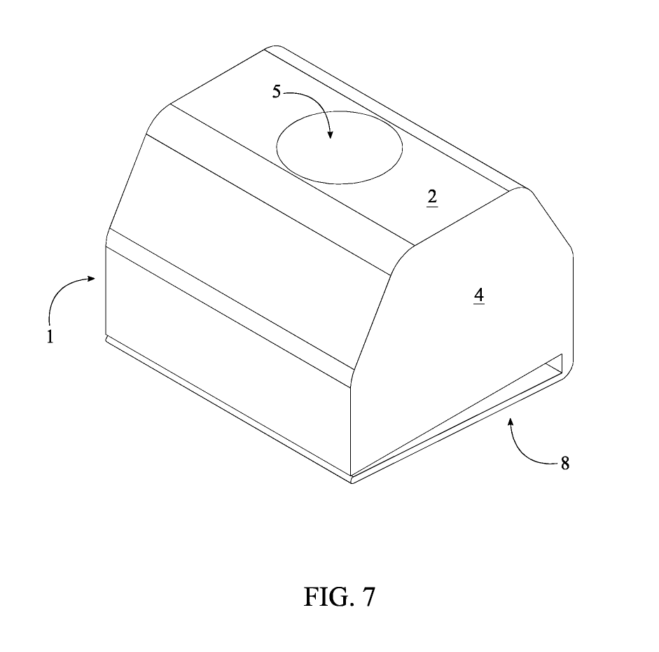

In reference to FIG. 7, the present invention comprises a clip 8 that functions as an attachment module for the prismatic body 1. More specifically, the clip 8 is terminally connected to the prismatic body 1 and positioned adjacent to the bottom surface 3. As a result, the clip 8 can secure the prismatic body 1 to the laminate and other ancillary products during the resin infusion process. Furthermore, since the clip 8 is positioned adjacent to the bottom surface 3, the clip 8 can easily secure the prismatic body 1 to a vertical surface or a curved surface without interfering with the resin infusion process. Even though the present invention utilizes the clip 8 as the attachment module, the present invention is not limited the clip 8 and can be any other type of attachment mechanism such as clamp fasteners, male or female fasteners, snap-fit fasteners, button fasteners, and adhesive fasteners.

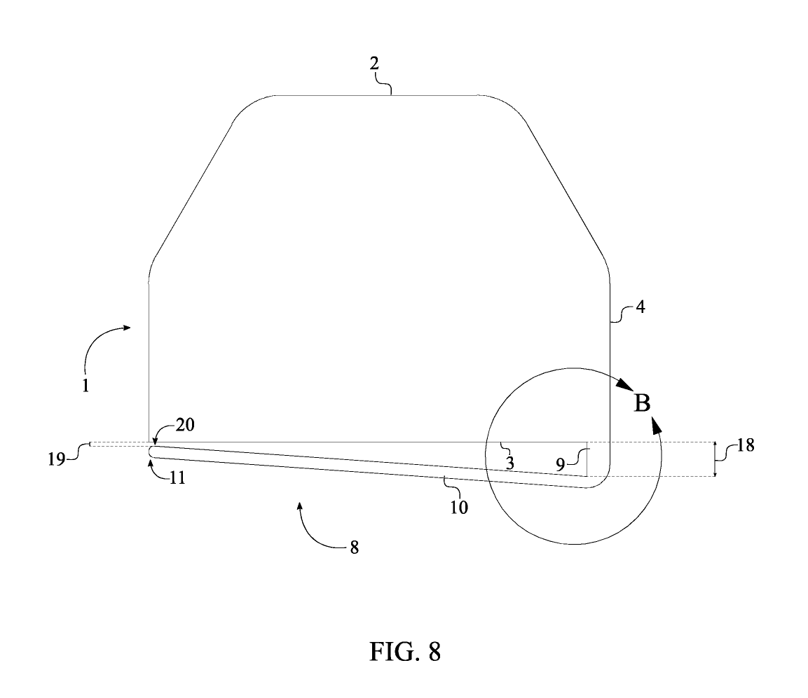

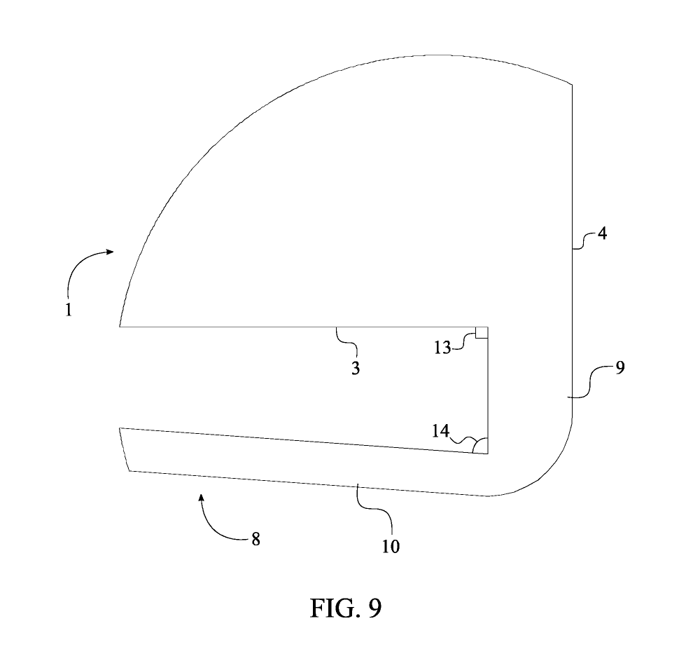

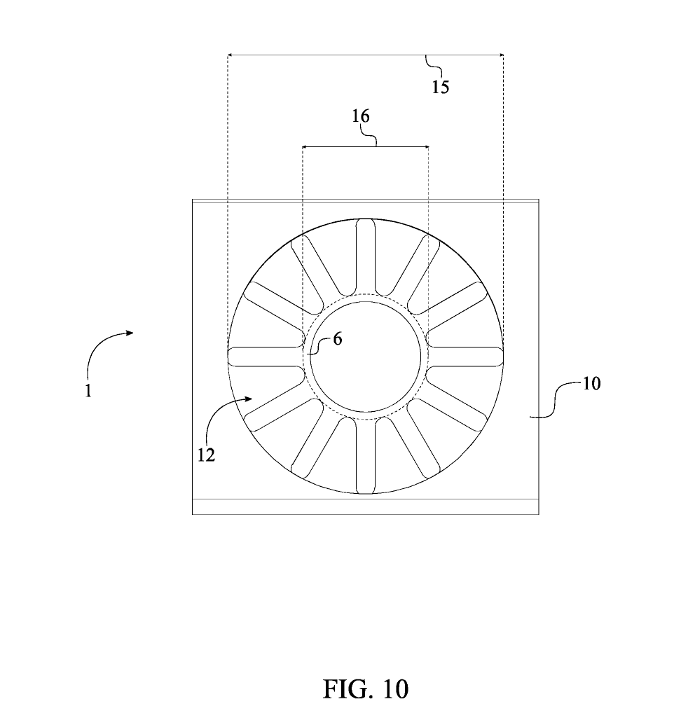

In reference to FIG. 8-10, a preferred embodiment of the clip 8 comprises a bridge 9, an attachment plate 10, and a plate opening 12. More specifically, the bridge 9 is terminally connected to the bottom surface 3. The bridge 9 and the bottom surface 3 delineate a right angle 13 in such a way that the bridge 9 perpendicularly extends outward from the bottom surface 3. The attachment plate 10 and the bridge 9 are terminally and angularly connected to each other as the attachment plate 10 is positioned opposite of the bottom surface 3. In other words, the attachment plate 10 is perimetrically encloses the bottom surface 3 to maximize the functionality of the attachment module thus delineating an acute angle 14 between the bridge 9 and the attachment plate 10. The plate opening 12, which provide a path for resin to flow through, is concentrically traversing through the attachment plate 10. Furthermore, the diameter 15 of the plate opening 12 is greater than a diameter 16 of the tube opening 5. The 15 diameter of the plate opening 12 is also maximized within the attachment plate 10 without hindering the structural integrity of the attachment plate 10. As a result, the plate opening 12 is able to maximize the resin flow from the plurality of channels 7 during the resin infusion process.

In reference to FIG. 8, when the preferred embodiment of the clip 8 is present, the present invention further comprises a gap 20. More specifically, the gap 20 is delineated in between the bottom surface 3 and a free end 11 of the attachment plate 10 so that the present invention can be secured. In order to eliminate accidental slippage, a length 18 of the bridge 9 is measured to be greater than a length 19 of the gap 20 so that the layer of flow media can be easily inserted parallel to the bottom surface 3 and crimped in between the free end 11 and the bottom surface 3.

Although the invention has been explained in relation to its preferred embodiment, it is to be understood that many other possible modifications and variations can be made without departing from the spirit and scope of the invention as hereinafter claimed.

What is claimed is:

1. An infusion terminal block comprises:
a prismatic body;
a tube opening;
a plurality of channels;
the prismatic body comprises a bottom surface;
the tube opening concentrically traversing through the prismatic body from the bottom surface;
the tube opening being positioned normal to the bottom surface;
the plurality of channels traversing into the prismatic body from the bottom surface; and
the plurality of channels being in fluid communication with the tube opening.

2. The infusion terminal block as claimed in claim 1 comprises:
the prismatic body further comprises a top surface;
the top surface and the bottom surface being positioned opposite of each other about the prismatic body;
the top surface and the bottom surface being laterally positioned of each other about the prismatic body;

3. The infusion terminal block as claimed in claim 2, wherein the top surface is a flat surface.

4. The infusion terminal block as claimed in claim 2, wherein the tube opening is perpendicularly positioned to the top surface and the bottom surface.

5. The infusion terminal block as claimed in claim 1 comprises:
a stopper;
the stopper being laterally connected within the tube opening; and
the stopper being positioned adjacent to the bottom surface.

6. The infusion terminal block as claimed in claim 5, wherein a diameter of the stopper is smaller than a diameter of the tube opening.

7. The infusion terminal block as claimed in claim 5 comprises:
the plurality of channels being radially distributed around the tube opening; and
the plurality of channels being in fluid communication with the tube opening through the stopper.

8. The infusion terminal block as claimed in claim 1 comprises:
a clip;
the clip being terminally connected to the prismatic body; and
the clip being positioned adjacent to the bottom surface.

9. The infusion terminal block as claimed in claim 8 comprises:
the clip comprises a bridge, an attachment plate, and a plate opening;
the bridge being terminally connected to the bottom surface;
the attachment plate and the bridge being terminally connected to each other, opposite of the bottom surface; and
the plate opening being concentrically traversing through the attachment plate.

10. The infusion terminal block as claimed in claim 9, wherein the attachment plate perimetrically encloses the bottom surface.

11. The infusion terminal block as claimed in claim 9, wherein the bridge and the bottom surface delineate a right angle.

12. The infusion terminal block as claimed in claim 9, wherein the bridge and the attachment plate delineate an acute angle.

13. The infusion terminal block as claimed in claim 9 comprises:
a gap;
the gap being delineated in between the bottom surface and a free end of the attachment plate; and
a length of the bridge being greater than a length of the gap.

14. The infusion terminal block as claimed in claim 9, wherein a diameter of the plate opening is greater than a diameter of the tube opening.

15. An infusion terminal block comprises:
a prismatic body;
a tube opening;
a plurality of channels;
a stopper;
the prismatic body comprises a top surface and a bottom surface;
the top surface being a flat surface;
the tube opening concentrically traversing through the prismatic body from the bottom surface;
the tube opening being positioned normal to the bottom surface;
the stopper being laterally connected within the tube opening;
the stopper being positioned adjacent to the bottom surface;
the plurality of channels traversing into the prismatic body from the bottom surface; and
the plurality of channels being in fluid communication with the tube opening.

16. The infusion terminal block as claimed in claim 15 comprises:
the top surface and the bottom surface being positioned opposite of each other about the prismatic body; and
the top surface and the bottom surface being laterally positioned of each other about the prismatic body.

17. The infusion terminal block as claimed in claim 15 comprises:
the tube opening being perpendicularly positioned to the top surface and the bottom surface;
a diameter of the stopper being smaller than a diameter of the tube opening;
the plurality of channels being radially distributed around the tube opening; and
the plurality of channels being in fluid communication with the tube opening through the stopper.

18. The infusion terminal block as claimed in claim 15 comprises:
a clip;
the clip being terminally connected to the prismatic body; and
the clip being positioned adjacent to the bottom surface.

19. The infusion terminal block as claimed in claim 18 comprises:
the clip comprises a bridge, an attachment plate, and a plate opening;
the bridge being terminally connected to the bottom surface;
the attachment plate and the bridge being terminally connected to each other, opposite of the bottom surface; and
the plate opening being concentrically traversing through the attachment plate.

20. The infusion terminal block as claimed in claim 18 comprises:
a gap;
the bottom surface being perimetrically enclosed by the attachment plate;
a right angle being delineated by the bridge and the bottom surface;
an acute angle being delineated by the bridge and the attachment plate;
the gap being delineated in between the bottom surface and a free end of the attachment plate;
a length of the bridge being greater than a length of the gap; and
a diameter of the plate opening is greater than a diameter of the tube opening.
